(19) United States
(12) Patent Application Publication
(10) Pub. No.: US 2020/0228369 A1
(43) Pub. Date: Jul. 16, 2020

(54) SYSTEMS AND METHODS FOR DISPLAY OF BUILDING MANAGEMENT USER INTERFACE USING MICROSERVICES

(71) Applicant: Johnson Controls Technology Company, Auburn Hills, MI (US)

(72) Inventors: Youngchoon Park, Brookfield, WI (US); Hemlata Tiwari, Lohagaon Pune (IN); Rima Mahato, West Bengal (IN); Kajol Uttam Kuwad, Pune (IN); Meghna Kulkarni, Pune (IN); Pallavi Ravindra Gabhane, Amravati (IN)

(73) Assignee: Johnson Controls Technology Company, Auburn Hills, MI (US)

(21) Appl. No.: 16/249,784

(22) Filed: Jan. 16, 2019

(51) Int. Cl. H04L 12/28; G06F 3/0484

(52) U.S. Cl. CPC H04L 12/2827; G06F 3/04847; H04L 12/282; H04L 12/2812

(57) ABSTRACT

A method for a processing circuit to display a graphical user interface (GUI) for a building management system (BMS). The method includes retrieving structured data from a display service executed by the processing circuit, wherein the structured data is a library. The method further includes generating a tag based on the structured data, wherein the tag associates interface data and bound data from a number of different data sources. The interface data describing an arrangement of an element of the GUI, and the bound data describing content of the element. The bound data is associated with the element according to the arrangement. The interface data and bound data are selected by a user. The method further includes displaying, on a display of a client device, the GUI based on the tag. The GUI may be used in different formats by associating the interface data with a different one of bound data, or the bound data with a different one of the interface data.

### BACKGROUND

The present disclosure relates generally to a building management system and more particularly to displaying building management system information.

A building management system (BMS) is, in general, a system of devices configured to control, monitor, and manage equipment in or around a building or building area. A BMS can include, for example, an HVAC system, a security system, a lighting system, a fire alerting system, any other system that is capable of managing building functions or devices, or any combination thereof. With the advent of advanced building management systems today, it is becoming increasingly viable to monitor a multitude of components within a building. Operators use user interfaces to interact with the BMS. Disparate user interfaces representing disparate components lead to confusion and increase user errors. Uniformly representing a multitude of components using a user interface is therefore desirable.

### SUMMARY

One implementation of the present disclosure is a method for a processing circuit to display a graphical user interface (GUI) for a building management system (BMS). The method includes retrieving structured data from a display service executed by the processing circuit, wherein the structured data is a library. The method further includes generating a tag based on the structured data, wherein the tag associates interface data and bound data from a number of different data sources. The interface data describing an arrangement of an element of the GUI, and the bound data describing content of the element. The bound data is associated with the element according to the arrangement. The interface data and bound data are selected by a user. The method further includes displaying, on a display of a client device, the GUI based on the tag. The GUI may be used in different formats by associating the interface data with a different one of bound data, or the bound data with a different one of the interface data.

In some embodiments the element is a virtual representation of a physical system or device, person or group of people, or space or group of spaces. In some embodiments an application programming interface (API) changes a source of the bound data. In some embodiments a client device displays the graphical user interface based on the tag. In some embodiments each of the number of different data sources use different communications protocols to communicate.

Another implementation of the present disclosure includes a building management system (BMS) configured to display a graphical user interface (GUI). The BMS includes a processing circuit configured to receive interface data and bound data from a number of different data sources, the interface data describing an arrangement of an element of the GUI, and the bound data describing content of the element. The processing circuit is further configured to associate the bound data with the element according to the arrangement and send structured data to a client device to display the GUI.

In some embodiments, the element is a virtual representation of a physical system or device, person or group of people, or space or group of spaces. In some embodiments, an application programming interface (API) changes a source of the bound data. In some embodiments, the client device generates a tag to display the graphical user interface. In some embodiments, the processing circuit uses different communications protocols to communicate with each of the number of different data sources. In some embodiments, the number of different data sources are backend micro-services, wherein the backend micro-services are coupled to one or more other backend micro-services or data servers. In some embodiments, the arrangement is standardized across different bound data sources.

Another implementation of the present disclosure includes a system for displaying a building management system (BMS) graphical user interface (GUI). The system includes one or more client devices configured to render one or more applications, the one or more applications configured to receive BMS data and display the BMS data in a GUI. The system further includes a processing circuit configured to provide a display service, the display service configured to receive interface data and bound data from a number of different data sources, the interface data describing an arrangement of an element of the GUI, and the bound data describing content of the element. The processing circuit further configured to associate the bound data with the element according to the arrangement, create structured data including one or more elements, and send the structured data to the one or more applications.

In some embodiments, the element is a virtual representation of a physical system or device, person or group of people, or space or group of spaces. In some embodiments, an application programming interface (API) allows a user to change a source of the BMS data. In some embodiments, the processing circuit uses different communication protocols to communicate with each of the number of different data sources. In some embodiments, the number of different data sources are backend micro-services, wherein the backend micro-services are coupled to one or more other backend micro-services or data servers. In some embodiments, the graphical user interface is standardized across different bound data sources. In some embodiments, the processing circuit allows a user to edit the bound data. In some embodiments, the one or more applications are configured to securely subscribe to receive the structured data.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a building equipped with a HVAC system, according to an exemplary embodiment.

FIG. 2 is a schematic block diagram of a waterside system that may be used in conjunction with the building of FIG. 1, according to an exemplary embodiment.

FIG. 3 is a schematic block diagram of an airside system that may be used in conjunction with the building of FIG. 1, according to an exemplary embodiment.

FIG. 4 is a schematic block diagram of a BMS which can be used in the building of FIG. 1, according to some embodiments.

FIG. 5 is a schematic block diagram of a system for displaying a user interface which can be implemented by the BMS of FIG. 4, according to an exemplary embodiment.

FIG. 6 is a flowchart showing an example method of displaying a user interface, according to an exemplary embodiment.

FIG. 7 is an example of code describing a tag which can be generated by the system of FIG. 5, according to some embodiments.

FIG. 8 is a user interface of a BMS which can be generated from the tag of FIG. 7, according to some embodiments.

### DETAILED DESCRIPTION

### Overview

Referring generally to the FIGURES, systems and methods for generating, managing, and displaying a user interface which provides building management system (BMS) information is shown, according to various exemplary embodiments. A BMS may routinely provide information associated with the systems under management. BMS information may be displayed in many formats depending on the display device. Furthermore, disparate BMS displays may require similar graphical elements despite having disparate functionality. Therefore, it is desirable for a BMS system to enable reuse of common graphical elements across disparate devices, disparate displays, and disparate data sources. For instance, reusable graphical elements that may be paired with application specific data to reduce development and maintenance time. Furthermore, standardized displays across display devices and display applications reduces user error by creating a similar look and feel to disparate displays. The user interface of the present disclosure can use web components standards to encapsulate front-end microservices with back-end microservices as a full feature capable of import into any application. Examples of user interfaces that can be implemented can be found in U.S. patent application Ser. No. 16/175,507 filed Oct. 30, 2018, the entirety of which is incorporated by reference herein.

According to aspects described herein, tags may be generated that link generic graphical elements to specific content for use in a reusable graphical user interface. Tags may be used in a BMS system to reuse graphical elements and standardize the look and feel of graphical user interfaces to reduce user error and save on development and maintenance time. The system of the present disclosure may route graphical elements complete with visual representation and back-end logic for use in an application or display device.

### Building Management System and HVAC System

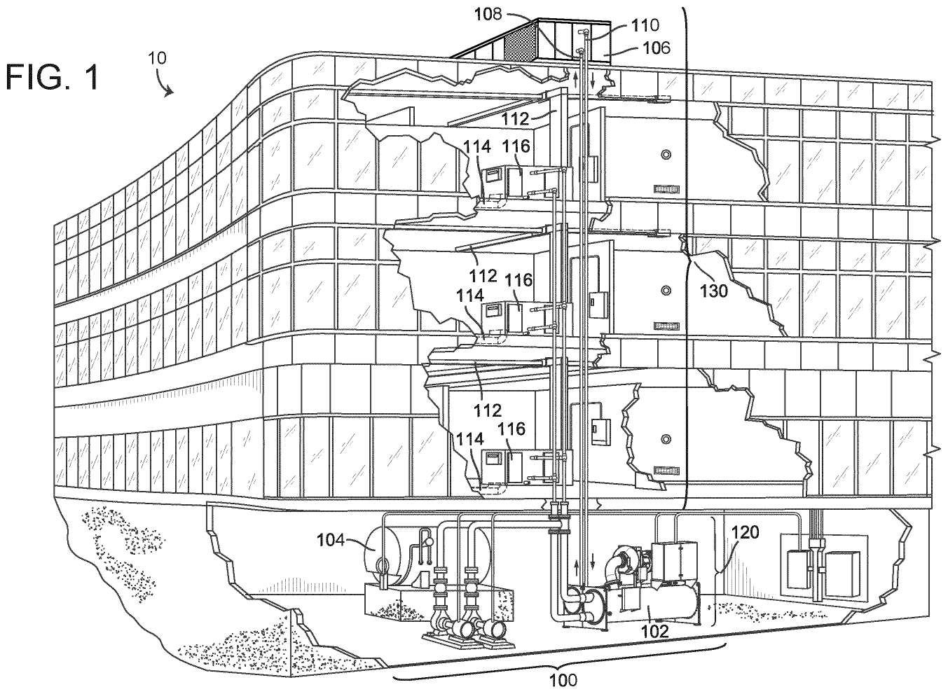

Referring now to FIGS. 1-3, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

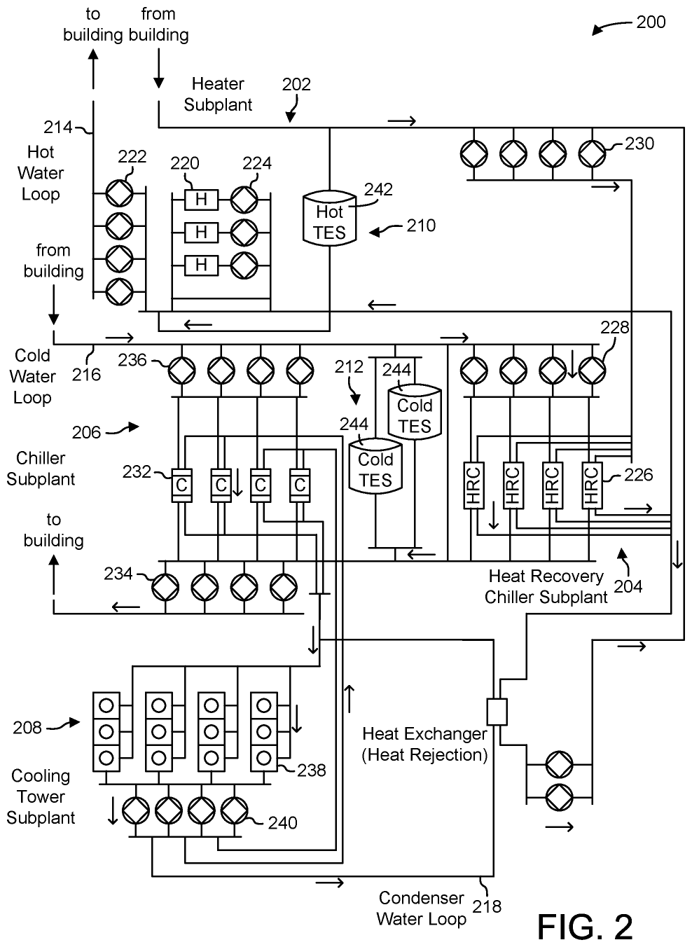

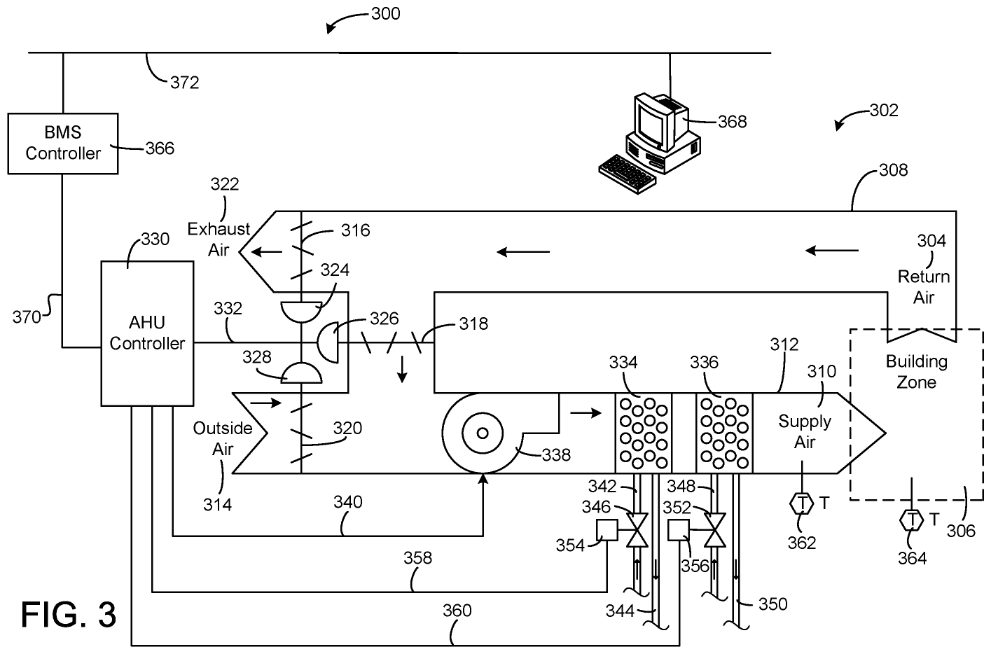

The BMS that serves building 10 includes an HVAC system 100. HVAC system 100 can include HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve set-point conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust air damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200(e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a set-point temperature for supply air 310 or to maintain the temperature of supply air 310 within a set-point temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, set-points, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

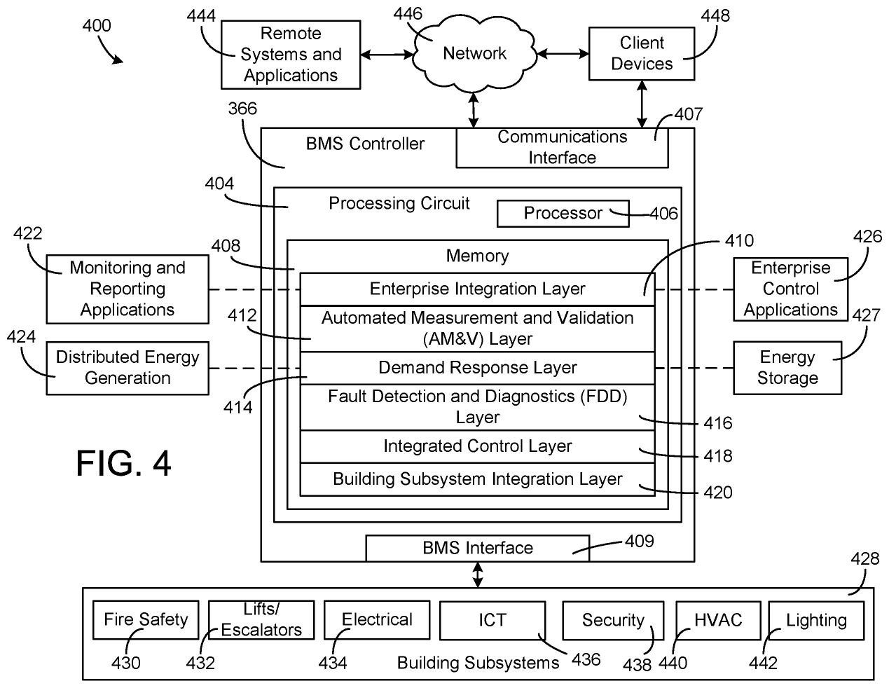

Referring now to FIG. 4, a block diagram of a building management system (BMS) 400 is shown, according to an example embodiment. BMS 400 can be implemented in building 10 to automatically monitor and control various building functions. BMS 400 is shown to include BMS controller 366 and building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an example embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translates communications (e.g., sensor data, input signals, output signals, etc.) across multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an example embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an example embodiment, integrated control layer 418 includes control logic that uses inputs and outputs from building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to an example embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

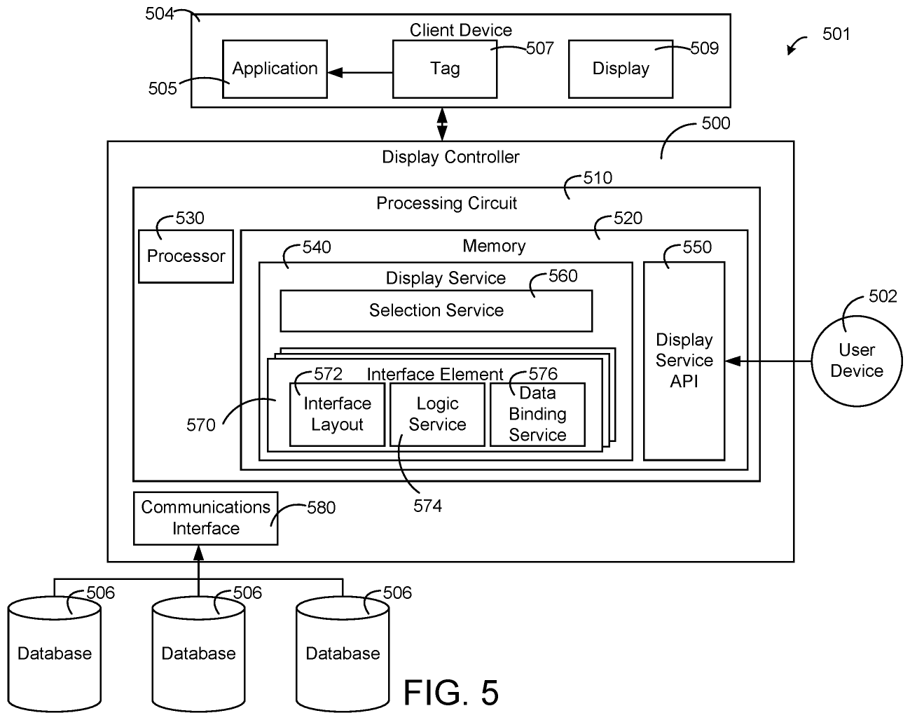

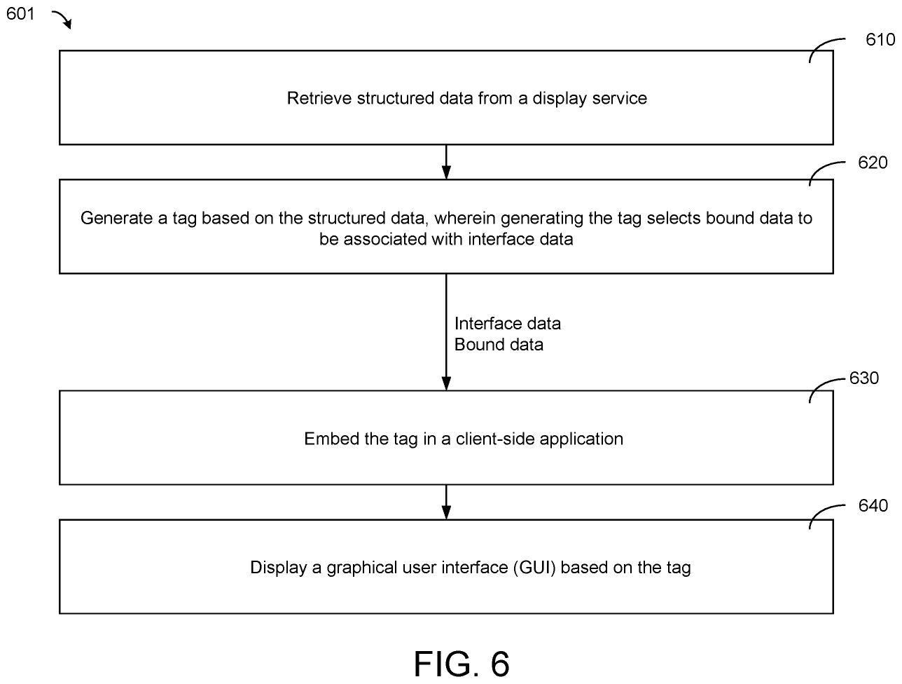

Referring now to FIG. 5, a system 501 for displaying a graphical user interface (GUI) is shown, according to an exemplary embodiment. System 501 may be used for displaying information related to various buildings (e.g., building 10 as described above with reference to FIG. 1). System 501 may be implemented in the BMS controller 366, the remote systems and applications 444, and/or the client devices 448 of FIG. 4 and/or other systems not mentioned herein. System 501 can be configured to generate a graphical user interface, as described in greater detail with further reference to FIGS. 6-8. System 501 can standardize user interface elements to reflect uniformity across different user interfaces and dashboards and reduce the need for developers to make similar user interface elements to display data every time there is a request for it. System 501 can be configured to be produce reusable user interfaces through encapsulation as described in greater detail with further reference to FIGS. 6-8.

System 501 is shown to include client device 504, display controller 500, user device 502, and database(s) 506. Display controller 500 may store generic display components and bind specific data to the generic display components to produce reusable display elements.

Display controller 500 may include processing circuit 510 and/or communications interface 580. Communications interface 580 may be communications interface 407 from FIG. 4 or another device or component altogether. Communications interface 580 may facilitate communications between display controller 500 and database(s) 506. Communications interface 580 can be or include wired or wireless communications interfaces (e.g., jacks, antennas, transmitters, receivers, transceivers, wire terminals, etc.) for conducting data communications with database(s) 506.

Processing circuit 510 may include processor 530 and/or memory 520. Processor 530 can be a general purpose processor, an application specific integrated circuit (ASIC), one or more field programmable gate arrays (FPGAs), a group of processing components, or other suitable electronic processing components.

Memory 520 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 520 can be or include volatile memory or non-volatile memory. Memory 520 can include database components, object code components, script components, or any other type of information structure for supporting the various activities and information structures described in the present application. According to an example embodiment, memory 520 is communicably connected to processor 530 via processing circuit 510 and includes computer code for executing one or more processes described herein.

Memory may include display service 540 and/or display service application programming interface (API) 550. Display service API 550 can be configured to interface with other systems, devices, and processes to allow interaction with core services and other components of display service 540. User device 502 may interface with display service API 550 to add, remove, and/or modify functions of display service 540. In an example, display service API 550 could change interactions between elements of display service 540 or change which of database(s) 506 provide data to display service 540.

Display service 540 may perform the back-end functions required to display a GUI on client device 504. Display service 540 may include subcomponents or functions such as front-end microservices, back-end microservices, and/or a coupled system thereof. Display service 540 may be implemented in display controller 500, client device 504, and/or another device or distributed throughout other devices not mentioned herein. Display service 540 may be configured to interface with various external dependencies (e.g., libraries, frameworks, etc.) through a standardization scheme (such as web components).

Still referring to FIG. 5, display service 540 may include selection service 560 and/or a number of interface elements 570. Selection service 560 can be configured to select between one or more interface element(s) 570 based on information from user device 502, client device 504, database(s) 506, and/or other devices or elements not listed herein. Selection service 560 can be configured to act as a router to decide which services of display service 540 to provide.

Interface element(s) 570 may be a complete graphical user interface structure. For example, interface element(s) 570 could include visual graphical elements, embedded back-end logic, interactive elements, and/or other embedded graphical elements (e.g., widgets, applications, toolboxes, etc.). Interface element(s) 570 may interact with various external services or may be integrated front-end back-end systems altogether. In some embodiments, interface element(s) 570 include subcomponents or functions such as front-end microservices, back-end microservices, and/or a coupled system thereof In some embodiments, interface element(s) 570 are selectively routed by selection service 560.

Interface element(s) 570 may include interface layout 572, logic service 574, and/or data binding service 576. Interface layout 572 can be a data structure describing an arrangement of a graphical user interface. Interface layout 572 may include graphical elements or link to graphical elements. Interface layout 572 may provide a means to modify existing graphical elements or create new graphical elements. Interface layout 572 may include markers, links, tags or other distinguishers to be used by other systems or components in binding outside data to a graphical user interface. Interface layout 572 may provide a graphical user interface for a BMS to visualize information related to various buildings (e.g., building 10 as described above with reference to FIG. 1).

Still referring to FIG. 5, logic service 574 can be configured to provide interactive features to a graphical user interface. Logic service 574 may be or interact with outside services, dependencies or frameworks to control, animate, or otherwise affect a graphical user interface.

In some embodiments, logic service 574 may be coupled to interface layout 572. Logic service 574 may be a cloud based service or may be a locally hosted and executed service depending on implementation.

Data binding service 576 may be configured to link, connect, or otherwise associate data with a graphical user interface. Data binding service 576 may bind data from one or more database(s) 506. Data binding service 576 may be coupled to interface layout 572 and/or logic service 574 to provide data, content or other external information. Data binding service 576 may be a back-end process or system (e.g., a microservice, subroutine, thread, gateway, etc.). Data binding service 576 may bind different data to different graphical user interface elements. Data binding service 576 may be a cloud based service or may be a locally hosted and executed service depending on implementation. Data binding service 576 may interface with display service API 550 to allow external selection of data sources. Data binding service 576 may bind data based on a distinguisher embedded in a graphical user interface. For example, data binding service 576 could insert a specific company logo in a generic graphical user interface embedded with a logo tag in the banner.

Still referring to FIG. 5, client device 504 may be one of the client devices 448 of FIG. 4 or another device altogether. Client device 504 may include an application 505, tag 507, and/or display 509. Client device 504 may be configured to display a graphical user interface on display 509. Display 509 may be any display known in the art to render, visualize, or otherwise present information to a user. Display 509 may be part of client device 504, may be part of another device, or may be a standalone device altogether.

Application 505 may be a program configured to display BMS data such as information related to various buildings (e.g., building 10 as described above with reference to FIG. 1). Application 505 may be coupled to display service 540 to facilitate displaying information. Application 505 may be displayed on display 509. Application 505 may interface with an API (such as display service API 550). Application 505 may receive a complete graphical user interface from display service 540, or may receive a generic graphical user interface to be augmented with specific data.

Tag 507 may be produced by client device 504, display controller 500, and/or another device or system altogether. Tag 507 may associate, link, or otherwise reference back to bound data associated with a graphical user interface. Tag 507 may be embedded in application 505 to provide a reusable graphical element to application 505. Tag 507 may eliminate the need for developers to continuously remake common graphical elements by linking specific data to a reusable generic graphical element. Tag 507 may interface with selection service 560 to selectively route a number of interface elements from interface element(s) 570. Tag 507 may encapsulate all services associated with a graphical user interface by binding front-end microservices with back-end microservices according to web components standards to allow for readily implemented graphical elements.

Still referring to FIG. 5, database(s) 506 may be configured to store information relating to a BMS. Information may be sourced from a variety of database(s) 506 according to the BMS. For example, utility data may be sources from a first database while security data may be sources from a second database. Database(s) 506 may be communicably coupled to communications interface 580 to provide BMS data to other systems or devices. Database(s) 506 may include memory (e.g., memory, memory unit, storage device, etc.) or one or more devices (e.g., RAM, ROM, Flash memory, hard disk storage, etc.) for storing data and/or computer code for completing or facilitating the various processes, layers and modules described in the present application. Database(s) 506 can be or include volatile memory or non-volatile memory. Database(s) 506 can include database components, object code components, script components, or any other type of information structure for supporting the various activities and information structures described in the present application.

Referring now to FIG. 6, a flowchart showing an example method 601 of displaying a BMS graphical user interface is shown, according to an exemplary embodiment. The method 601 may be implemented using the various components described above (e.g., those shown in FIG. 1-5).

At step 610, and in some embodiments, the display device (e.g., client device 504) retrieves structured data (e.g., interface element(s) 570) from a display service (e.g., display service 540). In some embodiments, structured data may include a graphical user interface element with embedded bound data, while in some embodiments structured data may include references or links to a graphical user interface, or a service for displaying a graphical user interface. In some embodiments, structured data may be standardized (as in a web components framework) or otherwise compatible with external systems or components (e.g., compatible with various libraries, frameworks, APIs, routers, gateways etc.). In some embodiments, structured data may be or include a library with front-end microservices, back-end microservices and standardized web components. In some embodiments, security can be increased by limiting retrieval of structured data by managing read-write access, granting private access, direct private publishing, and/or adding collaborators.

At step 620, and in some embodiments, a tag is generated based on the structured data. The tag may be tag 507 from FIG. 5. In some embodiments, the tag is generated by a display device (e.g., client device 504) and in some embodiments the tag is generated by another device or system (e.g., display service 540). In some embodiments, generating the tag may select bound data to be associated with interface data. For example, generating the tag could embed a specific logo into a generic graphical user interface. In some embodiments, the tag acts to further link user interface logic to a generic user interface element. In some embodiments, the tag acts as a reference to a complete graphical user interface and may be embedded in other applications, services and/or devices to display the complete graphical user interface thereon.

At step 630, and in some embodiments, the tag is embedded in a client-side application (e.g., application 505). In some embodiments, embedding the tag may provide display of a complete graphical user interface referenced by the tag. In some embodiments, a BMS display system may use the tag to uniformly display common graphical user interfaces throughout an application with a shared look and feel. In some embodiments, the tag may reduce the need for developers to recreate common graphical elements for disparate systems displaying similar data. For example, a BMS system configured to display a building network could use a tag referencing a graphical user interface to display the building network on a mobile device application and/or a web application. At step 640, and in some embodiments, a display device displays a graphical user interface using the tag. The display device (e.g., client device 504) may fetch a graphical user interface using the tag as described in detail above.

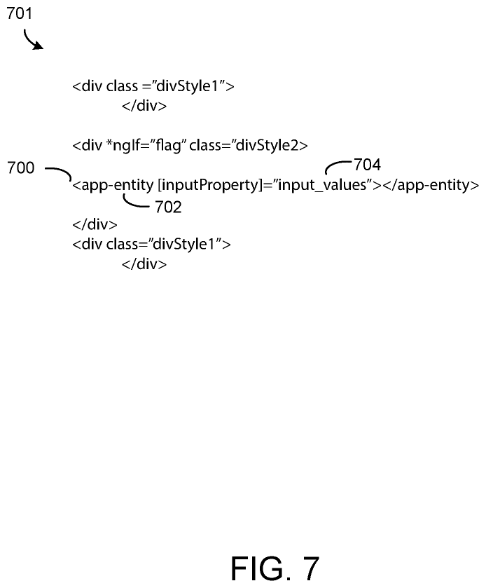

Referring now to FIG. 7, an example of code 701 describing a tag associated with a graphical user interface is shown, according to an exemplary embodiment. In some embodiments code 701 is in another programming language or is represented in another manner. Code 701 can include tag 700. Tag 700 may be tag 507. Tag 700 can link a complete graphical user interface and/or provide display of a graphical element to another device, system, and/or application. For example, tag 700 can be embedded in a web page to display a complete BMS entity viewer. Tag 700 can include name 702 and/or input 704.

Name 702 can descriptively specify a functionality. For example, a tag for displaying an entity viewer could have the name “app-entity.” Name 702 can be used by the system (e.g., system 501, client device 504, displayer controller 500, selection service 560 etc.) to select a graphical element (for example one of interface element(s) 570) to display. In some embodiments, name 702 may specify a generic graphical element (such as interface layout 572). In some embodiments, input 704 can link (as described in detail with reference to FIG. 5) specific data (e.g., through logic service 574, data binding service 576, etc.) to a generic graphical element (for example one of interface element(s) 570) specified by name 702. In some embodiments, tag 700 is reusable for repeated display of common graphical elements.

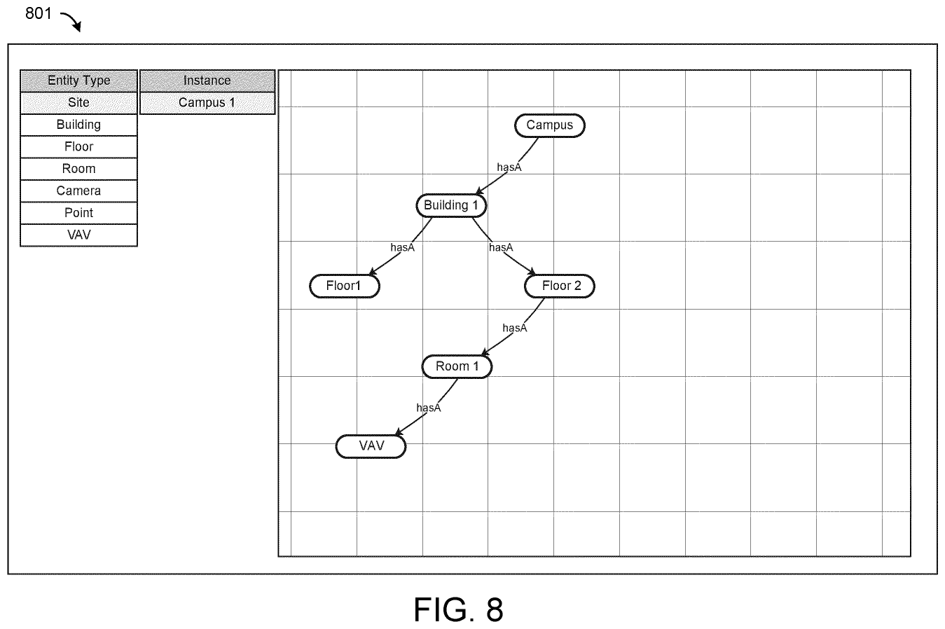

Referring now to FIG. 8, a graphical user interface (GUI) 801 of a BMS is shown, according to an exemplary embodiment. GUI 801 may be any graphical user interface or graphical user interface element. In some embodiments, GUI 801 is specified by tag 700. For example, a tag 700 for an entity viewer with name 702 “app-entity” may produce an entity viewer GUI 801. GUI 801 may be displayed on any display device known in the art (e.g., client device 504). GUI 801 may be displayed across multiple display devices with the same tag 700. The content of GUI 801 may change based on input 704. GUI 801 can be produced in any manner using tag 700 (such as method 601 described in detail with reference to FIG. 6).

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for a processing circuit to display a graphical user interface (GUI) for a building management system (BMS), the method comprising:
retrieving structured data from a display service executed by the processing circuit, wherein the structured data is a library;
generating a tag based on the structured data, wherein the tag associates interface data and bound data from a plurality of different data sources, the interface data describing an arrangement of an element of the GUI, and the bound data describing content of the element, wherein the bound data is associated with the element according to the arrangement;
wherein the interface data and bound data are selected by a user;
displaying, on a display of a client device, the GUI based on the tag; and
whereby the GUI may be used in different formats by associating the interface data with a different one of bound data, or the bound data with a different one of the interface data.

2. The method of claim 1, wherein the element is a virtual representation of a physical system or device, person or group of people, or space or group of spaces.

3. The method of claim 1, wherein an application programming interface (API) changes a source of the bound data, wherein the source is an endpoint.

4. The method of claim 1, wherein a client displays the graphical user interface based on the tag, wherein the client is a web browser.

5. The method of claim 1, wherein the tag encapsulates one or more disparate external dependencies associated with the GUI.

6. A building management system (BMS) configured to display a graphical user interface (GUI) comprises:
a processing circuit configured to:
receive, based on a user selection, interface data and bound data from a plurality of different data sources, the interface data describing an arrangement of an element of the GUI, and the bound data describing content of the element;
associate the bound data with the element according to the arrangement; and
send structured data to a client device to display the GUI, wherein the structured data is a library encapsulating the element.

7. The building management system (BMS) of claim 6, wherein the element is a virtual representation of a physical system or device, person or group of people, or space or group of spaces.

8. The building management system (BMS) of claim 6, wherein an application programming interface (API) changes a source of the bound data, wherein the source is an endpoint.

9. The building management system (BMS) of claim 6, wherein the client device generates a tag to display the graphical user interface.

10. The building management system (BMS) of claim 9, wherein the tag encapsulates one or more external dependencies associated with the graphical user interface.

11. The building management system (BMS) of claim 6, wherein the plurality of different data sources are backend micro-services, wherein the backend micro-services are coupled to one or more other backend micro-services or data servers.

12. The building management system (BMS) of claim 6, wherein the arrangement is standardized across different bound data sources.

13. A system for displaying a building management system (BMS) graphical user interface (GUI), the system comprising:
one or more client devices configured to render one or more applications, the one or more applications configured to receive BMS data and display the BMS data in a GUI; and
a processing circuit configured to provide a display service, the display service configured to:
receive, based on a user selection, interface data and bound data from a plurality of different data sources, the interface data describing an arrangement of an element of the GUI, and the bound data describing content of the element;
associate the bound data with the element according to the arrangement; and
create structured data comprising one or more elements; and
send the structured data to the one or more applications.

14. The system of claim 13, wherein the element is a virtual representation of a physical system or device, person or group of people, or space or group of spaces.

15. The system of claim 13, wherein an application programming interface (API) allows a user to change a source of the BMS data, wherein the source is an endpoint.

16. The system of claim 13, wherein the one or more client devices are web browsers.

17. The system of claim 13, wherein the plurality of different data sources are backend micro-services, wherein the backend micro-services are coupled to one or more other backend micro-services or data servers.

18. The system of claim 13, wherein the graphical user interface is standardized across different bound data sources.

19. The system of claim 13, wherein the processing circuit allows a user to edit the bound data.

20. The system of claim 13, wherein the one or more applications are configured to securely subscribe to receive the structured data.
